(19) United States
(12) Patent Application Publication
(10) Pub. No.: US 2013/0232215 A1
(43) Pub. Date: Sep. 5, 2013

(54) VIRTUALIZED DATA STORAGE SYSTEM ARCHITECTURE USING PREFETCHING AGENT

(71) Applicants: Nitin Gupta, Fremont, CA (US); Nagendra Subramanya, Sunnyvale, CA (US); Oleg Smolsky, Santa Clara, CA (US)

(72) Inventors: Nitin Gupta, Fremont, CA (US); Nagendra Subramanya, Sunnyvale, CA (US); Oleg Smolsky, Santa Clara, CA (US)

(73) Assignee: RIVERBED TECHNOLOGY, INC., San Francisco, CA (US)

(21) Appl. No.: 13/471,956

(22) Filed: May 15, 2012

Related U.S. Application Data
(60) Provisional application No. 61/606,893, filed on Mar. 5, 2012.

(51) Int. Cl. G06F 15/167

(52) U.S. Cl. 709/213

(57) ABSTRACT

Virtual storage arrays consolidate data storage from branch locations at data centers. The virtual storage array appears to storage clients as a local data storage; however, the virtual storage array data is actually stored at a data center. To overcome the bandwidth and latency limitations of wide area networks between branch locations and the data center, systems and methods predict, prefetch, and cache at the branch location storage blocks that are likely to be requested in the future by storage clients. When this prediction is successful, storage block requests are fulfilled from branch locations' storage block caches. Predictions may leverage an understanding of the semantics and structure of the high-level data structures associated with the storage blocks. Prefetching agents on storage clients monitor storage requests to determine the associations between requested storage blocks and the corresponding high-level data structures as well as other attributes useful for prediction.

### CROSS-REFERENCE TO RELATED APPLICATIONS

This application claims priority to U.S. Provisional Patent Application No. 61/606,893, filed Mar. 5, 2012, and entitled “Virtualized Data Storage System Architecture Using Prefetching Agent,” which is incorporated by reference herein for all purposes. This application is related to U.S. patent application Ser. No. 12/730,179, entitled “Virtualized Data Storage Over Wide-Area Networks”, filed Mar. 23, 2010; U.S. patent application Ser. No. 12/730,192, entitled “Virtualized Data Storage Cache Management”, filed Mar. 23, 2010; and U.S. patent application Ser. No. 12/730,198, entitled “Virtual Data Storage System Optimizations”, filed Mar. 23, 2010; all of which are incorporated by reference herein for all purposes.

### BACKGROUND

The present invention relates generally to data storage systems, and systems and methods to improve storage efficiency, compactness, performance, reliability, and compatibility. Enterprises often span geographical locations, including multiple corporate sites, branch offices, and data centers, all of which are generally connected over a wide-are network (WAN). Although in many cases, servers are run in a data center and accessed over the network, there are also cases in which servers need to be run in distributed locations at the “edges” of the network. These network edge locations are generally referred to as branch locations in this application, regardless of the purposes of these locations. The need to operate servers at branch locations may arise from variety of reasons, including efficiently handling large amounts of newly written data and ensuring service availability during WAN outages.

The need to run servers at branch locations in a network, as opposed to a centralized data center location, leads to a corresponding requirement for data storage for those servers at the branch locations, both to store the operating system data for branch servers, in some cases, for user or application data. The branch data storage requires maintenance and administration, including proper sizing for future growth, data snapshots, archives, and backups, and replacements and/or upgrades of storage hardware and software when the storage hardware or software fails or branch data storage requirements change.

Although the maintenance and administration of data storage in general incurs additional costs, branch data storage is more expensive and inefficient than consolidated data storage at a centralized data center. Organizations often require on-site personnel at each branch location to configure and upgrade each branch's data storage, and to manage data backups and data retention. Additionally, organizations often purchase excess storage capacity for each branch location to allow for upgrades and growing data storage requirements. Because branch locations are serviced infrequently, due to their numbers and geographic dispersion, organizations often deploy enough data storage at each branch location to allow for months or years of storage growth. However, this excess storage capacity often sits unused for months or years until it is needed, unnecessarily driving up costs.

Although the consolidation of information technology infrastructure decreases costs and improves management efficiency, branch data storage is rarely consolidated at a network branch location, because the intervening WAN is slow and has high latency, making storage accesses unacceptably slow for branch client systems and application servers. Thus, organizations have previously been unable to consolidate data storage from multiple branches.

### BRIEF DESCRIPTION OF THE DRAWINGS

The invention will be described with reference to the drawings, in which:

FIG. 1 illustrates a virtualized data storage system architecture according to an embodiment of the invention;

FIG. 2 illustrates a method of prefetching storage blocks to improve virtualized data storage system performance according to an embodiment of the invention;

FIGS. 3A-3D illustrate example techniques for communicating storage block prefetching information between a prefetching agent and a virtual storage array interface according to embodiments of the invention; and

FIG. 4 illustrates an example computer system capable of a virtualized data storage system device according to an embodiment of the invention.

### SUMMARY

An embodiment of the invention uses virtual storage arrays to consolidate branch location-specific data storage at data centers connected with branch locations via wide area networks. The virtual storage array appears to a storage client as a local branch data storage; however, embodiments of the invention actually store the virtual storage array data at a data center connected with the branch location via a wide-area network. In embodiments of the invention, a branch storage client accesses the virtual storage array using storage block based protocols.

Embodiments of the invention overcome the bandwidth and latency limitations of the wide area network between branch locations and the data center by predicting storage blocks likely to be requested in the future by the branch storage client and prefetching and caching these predicted storage blocks at the branch location. When this prediction is successful, storage block requests from the branch storage client may be fulfilled in whole or in part from the branch location' storage block cache. As a result, the latency and bandwidth restrictions of the wide-area network are hidden from the storage client.

The branch location storage client uses storage block-based protocols to specify reads, writes, modifications, and/or deletions of storage blocks. However, servers and higher-level applications typically access data in terms of files in a structured file system, relational database, or other high-level data structure. Each entity in the high-level data structure, such as a file or directory, or database table, node, or row, may be spread out over multiple storage blocks at various non-contiguous locations in the storage device. Thus, prefetching storage blocks based solely on their locations in the storage device is unlikely to be effective in hiding wide-area network latency and bandwidth limits from storage clients.

An embodiment of the invention leverages an understanding of the semantics and structure of the high-level data structures associated with the storage blocks to predict which storage blocks are likely to be requested by a storage client in the near future. To do this, an embodiment of the invention includes a prefetching agent application, module, or process on every client, server, or other storage client directly interfacing with the virtual storage array.

The prefetching agent monitors data storage access requests, including data reads, data writes, and other storage operations, to determine the association between requested storage blocks and the corresponding high-level data structure entities, such as files, directories, or database elements, and/or other attributes useful for predicting future storage requests, such as the identity and/or type of the application requesting storage block access or other applications on the storage client, operating modes of the requesting application, virtual machine or other virtualization information, and any user or application inputs or outputs. The prefetching agent generates storage block prefetching data that indicates the association of storage blocks with corresponding high-level data structures and other attributes, such as the identity of the application requesting the storage blocks. In an embodiment, the storage block prefetching information is provided to the virtual storage array interface or used by the prefetching agent itself to help identify additional portions of the same or other high-level data structure entities that are likely to be accessed by the storage client. This embodiment of the invention then identifies the additional storage blocks corresponding to these additional high-level data structure entities. The additional storage blocks are then prefetched and cached at the branch location.

### DETAILED DESCRIPTION OF ILLUSTRATIVE EMBODIMENTS

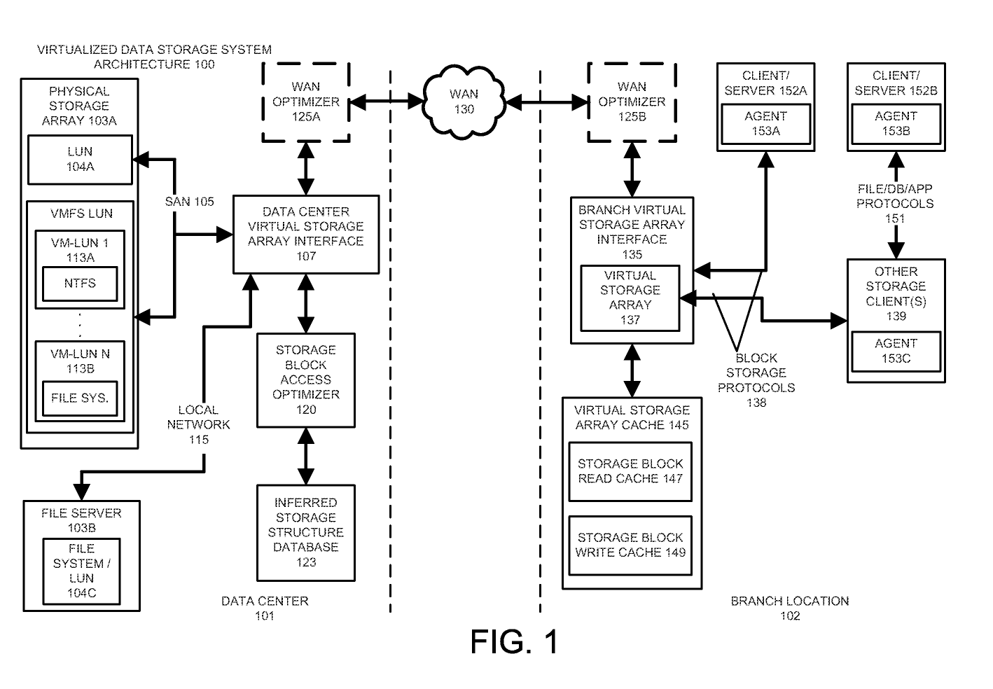

FIG. 1 illustrates a virtualized data storage system architecture 100 according to an embodiment of the invention. Virtualized data storage system architecture 100 includes a data center 101 connected with at least one branch network location 102 via a wide-area network (WAN) 130. Each branch location 102 includes at least one storage client 139, such as a file server, application server, database server, or storage area network (SAN) interface. A storage client 139 may be connected with a local-area network (LAN) 151, including routers, switches, and other wired or wireless network devices, for connecting with server and client systems and other devices 152B.

Previously, typical branch location installations also required a local physical data storage device for the storage client. For example, a prior typical branch location LAN installation may include a file server for storing data for the client systems and application servers, such as database servers and e-mail servers. In prior systems, this branch location's data storage is located at the branch location site and connected directly with the branch location LAN or SAN. The branch location physical data storage device previously could not be located at the data center 101, because the intervening WAN 130 is too slow and has high latency, making storage accesses unacceptably slow for storage clients.

An embodiment of the invention allows for storage consolidation of branch location-specific data storage at data centers connected with branch locations via wide area networks. This embodiment of the invention overcomes the bandwidth and latency limitations of the wide area network between branch locations and the data center. To this end, an embodiment of the invention includes virtual storage arrays.

In an embodiment, the branch location 102 includes a branch virtual storage array interface device 135. The branch virtual storage array interface device 135 presents a virtual storage array 137 to branch location users, such as the branch location storage client 139, such as a file or database server. A virtual storage array 137 can be used for the same purposes as a local storage area network or other data storage device. For example, a virtual storage array 137 may be used in conjunction with a storage client 139 such as a file server for general-purpose data storage, in conjunction with a database server for database application storage, or in conjunction with an e-mail server for e-mail storage. However, the virtual storage array 137 stores its data at a data center 101 connected with the branch location 102 via a wide area network 130. Multiple separate virtual storage arrays, from different branch locations, may store their data in the same data center and, as described below, on the same physical storage devices.

Because the data storage of multiple branch locations is consolidated at a data center, the efficiency, reliability, cost-effectiveness, and performance of data storage is improved. An organization can manage and control access to their data storage at a central data center, rather than at large numbers of separate branch locations. This increases the reliability and performance of an organization's data storage. This also reduces the personnel required at branch location offices to provision, maintain, and backup data storage. It also enables organizations to implement more effective backup systems, data snapshots, and disaster recovery for their data storage. Furthermore, organizations can plan for storage growth more efficiently, by consolidating their storage expansion for multiple branch locations and reducing the amount of excess unused storage. Additionally, an organization can apply optimizations such as compression or data deduplication over the data from multiple branch locations stored at the data center, reducing the total amount of storage required by the organization.

In an embodiment, branch virtual storage array interface 135 may be a stand-alone computer system or network appliance or built into other computer systems or network equipment as hardware and/or software. In a further embodiment, a branch location virtual storage array interface 135 may be implemented as a software application or other executable code running on a client system or application server.

In an embodiment, a branch location virtual storage array interface 135 includes one or more storage array network interfaces and supports one or more storage block network protocols to connect with one or more storage clients 139 via a local storage area network (SAN) 138. Examples of storage array network interfaces suitable for use with embodiments of the invention include Ethernet, Fibre Channel, IP, and InfiniBand interfaces. Examples of storage array network protocols include ATA, Fibre Channel Protocol, and SCSI. Various combinations of storage array network interfaces and protocols are suitable for use with embodiments of the invention, including iSCSI, HyperSCSI, Fibre Channel, Fibre Channel over Ethernet, and iFCP. In cases where the storage array network interface uses Ethernet, an embodiment of the branch location virtual storage array interface can use the branch location LAN's physical connections and networking equipment for communicating with client systems and application services. In other embodiments, separate connections and networking equipment, such as Fibre Channel networking equipment, is used to connect the branch location virtual storage array interface with client systems and/or application services.

It should be noted that the branch location virtual storage array interface 135 allows storage clients such as storage client 139 to access data in the virtual storage array via storage block protocols, unlike file servers that utilize file-based protocols, databases that use database-based protocols, or application protocols such as HTTP or other REST-based application interfaces. For example, storage client 139 may be integrated with a file server that also provides a network file interface to the data in the virtual storage array 137 to client systems and other application servers via network file protocol 151 such as NFS or CIFS. In this example, the storage client 139 receives storage requests to read, write, or otherwise access data in the virtual storage array via a network file protocol. Storage client 139 then translates these requests into one or more corresponding block storage protocol requests for branch virtual storage array interface 135 to access the virtual storage array 137.

In a further embodiment, the storage client is integrated as hardware and/or software in a client or server 152A, including client systems such as a personal computer, tablet computer, smartphone, or other electronic communications device, or server systems such as an application server, such as a file server, database server, or e-mail server. In another example, a client or server 152A communicates directly with the branch virtual storage array interface 135 via a block storage protocol 138, such as iSCSI. In this example, the client or server 152A acts as its own storage client.

In a further embodiment, the branch location virtual storage array interface 135 is integrated as hardware and/or software in a client or server 152A, including client systems such as a personal computer, tablet computer, smartphone, or other electronic communications device, or server systems such as an application server, such as a file server, database server, or e-mail server. In this embodiment, the branch location virtual storage array interface 135 can include application server interfaces, such as a network file interface, for interfacing with other application servers and/or client systems.

A branch location virtual storage array interface 135 presents a virtual storage array 137 to one or more storage clients 139 or 152A. To the storage clients 139 and 152A, the virtual storage array 137 appears to be a local storage array, having its physical data storage at the branch location 102. However, the branch location virtual storage array interface 135 actually stores and retrieves data from physical data storage devices located at the data center 101. Because virtual storage array data accesses must travel via the WAN 130 between the data center 101 LAN to a branch location 102 LAN, the virtual storage array 137 is subject to the latency and bandwidth restrictions of the WAN 130.

In an embodiment, the branch location virtual storage array interface 135 includes a virtual storage array cache 145, which is used to ameliorate the effects of the WAN 130 on virtual storage array 137 performance. In an embodiment, the virtual storage array cache 145 includes a storage block read cache 147 and a storage block write cache 149.

The storage block read cache 147 is adapted to store local copies of storage blocks requested by storage clients 139 and 152A. As described in detail below, the virtualized data storage system architecture 100 may attempt to predict which storage blocks will be requested by the storage clients 139 and 152A in the future and preemptively send these predicted storage blocks from the data center 101 to the branch 102 via WAN 130 for storage in the storage block read cache 147. If this prediction is partially or wholly correct, then when the storage clients 139 and 152A eventually request one or more of these prefetched storage blocks from the virtual storage array 137, an embodiment of the virtual storage array interface 135 can fulfill this request using local copies of the requested storage blocks from the block read cache 145. By fulfilling access requests using prefetched local copies of storage blocks from the block read cache 145, the latency and bandwidth restrictions of WAN 130 are hidden from the storage clients 139 and 152A. Thus, from the perspective of the storage clients 139 and 152A, the virtual storage array 137 appears to perform storage block read operations as if the physical data storage were located at the branch location 102.

To assist in the prediction and prefetching of storage blocks for caching in the storage block read cache 147, embodiments of the invention include prefetching agent applications, modules, or processes 153 that monitor activity of clients and servers 152 utilizing the virtual storage array 137. In an embodiment, a prefetching agent application, such as 153A or 153B, operates on the client or server, such as 152A or 152B, respectively. In further embodiments, prefetching agent applications may be installed on other storage clients that interface with the virtual storage array 137, such as prefetching agent 153C in storage client 139. Embodiments of the prefetching agent applications 153 may be implemented as an independent application; a background process; as part of an operating system; and/or as a device or filter driver. In further embodiments, if a client, server, or other storage client is implemented within a virtual machine or other type of virtualization system, the prefetching agent application may be implemented as above and/or as part of the virtual machine application or supporting virtualization platform.

Similarly, the storage block write cache 149 is adapted to store local copies of new or updated storage blocks written by the storage clients 139 and 152A. As described in detail below, the storage block write cache 149 temporarily stores new or updated storage blocks written by the storage clients 139 and 152A until these storage blocks are copied back to physical data storage at the data center 101 via WAN 130. By temporarily storing new and updated storage blocks locally at the branch location 102, the bandwidth and latency of the WAN 130 is hidden from the storage clients 139 and 152A. Thus, from the perspective of the storage clients 139 and 152A, the virtual storage array 137 appears to perform storage block write operations as if the physical data storage were located at the branch location 102.

In an embodiment, the prefetching agent applications 153 may also monitor activities of clients and servers 152 to optimize the storage of new or updated data in the virtual storage array.

In an embodiment, the virtual storage array cache 145 includes non-volatile and/or redundant data storage, so that data in new or updated storage blocks are protected from system failures until they can be transferred over the WAN 130 and stored in physical data storage at the data center 101.

In an embodiment, the branch location virtual storage array interface 135 operates in conjunction with a data center virtual storage array interface 107. The data center virtual storage array interface 107 is located on the data center 101 LAN and may communicate with one or more branch location virtual storage array interfaces via the data center 101 LAN, the WAN 130, and their respective branch location LANs. Data communications between virtual storage array interfaces can be in any form and/or protocol used for carrying data over wired and wireless data communications networks, including TCP/IP.

In an embodiment, data center virtual storage array interface 107 is connected with one or more physical data storage devices 103 to store and retrieve data for one or more virtual storage arrays, such as virtual storage array 137. To this end, an embodiment of a data center virtual storage array interface 107 accesses a physical storage array network interface, which in turn accesses physical data storage array 103a on a storage array network (SAN) 105. In another embodiment, the data center virtual storage array interface 107 includes one or more storage array network interfaces and supports one or more storage array network protocols for directly connecting with a physical storage array network 105 and its physical data storage array 103a. Examples of storage array network interfaces suitable for use with embodiments of the invention include Ethernet, Fibre Channel, IP, and InfiniBand interfaces. Examples of storage array network protocols include ATA, Fibre Channel Protocol, and SCSI. Various combinations of storage array network interfaces and protocols are suitable for use with embodiments of the invention, including iSCSI, HyperSCSI, Fibre Channel over Ethernet, and iFCP. Embodiments of the data center virtual storage array interface 107 may connect with the physical storage array interface and/or directly with the physical storage array network 105 using the Ethernet network of the data center LAN and/or separate data communications connections, such as a Fibre Channel network.

In another embodiment, data center virtual storage array interface 107 may store and retrieve data for one or more virtual storage arrays, such as virtual storage array 137, using a network storage device, such as file server 103b. File server 103b may be connected with data center virtual storage array 137 via local-area network (LAN) 115, such as an Ethernet network, and communicate using a network file system protocol, such as NFS, SMB, or CIFS.

Embodiments of the data center virtual storage array interface 107 may utilize a number of different arrangements to store and retrieve virtual storage array data with physical data storage array 103a or file server 103b. In one embodiment, the virtual data storage array 137 presents a virtualized logical storage unit, such as an iSCSI or FibreChannel logical unit number (LUN), to storage clients 139 and 152A. This virtual logical storage unit is mapped to a corresponding logical storage unit 104a on physical data storage array 103a. Data center virtual storage array interface 107 stores and retrieves data for this virtualized logical storage unit using a non-virtual logical storage unit 104a provided by physical data storage array 103a. In a further embodiment, the data center virtual data storage array interface 107 supports multiple branch locations and maps each storage client's virtualized logical storage unit to a different non-virtual logical storage unit provided by physical data storage array 103a.

In another embodiment, virtual data storage array interface 107 maps a virtualized logical storage unit to a virtual machine file system 104b, which is provided by the physical data storage array 103a. Virtual machine file system 104b is adapted to store one or more virtual machine disk images 113, each representing the configuration and optionally state and data of a virtual machine. Each of the virtual machine disk images 113, such as virtual machine disk images 113a and 113b, includes one or more virtual machine file systems to store applications and data of a virtual machine. To a virtual machine application, its virtual machine disk image 113 within the virtual machine file system 104b appears as a logical storage unit. However, the complete virtual machine file system 104b appears to the data center virtual storage array interface 107 as a single logical storage unit.

In another embodiment, virtual data storage array interface 107 maps a virtualized logical storage unit to a logical storage unit or file system 104c provided by the file server 103c.

As described above, storage clients can interact with virtual storage arrays in the same manner that they would interact with physical storage arrays. This includes issuing storage commands to the branch location virtual storage interface using storage array network protocols such as iSCSI or Fibre Channel protocol. Most storage array network protocols organize data according to storage blocks, each of which has a unique storage address or location. A storage block's unique storage address may include logical unit number (using the SCSI protocol) or other representation of a logical volume.

In an embodiment, the virtual storage array provided by a branch location virtual storage interface allows a storage client to access storage blocks by their unique storage address within the virtual storage array. However, because one or more virtual storage arrays actually store their data within one or more of the physical data storage devices 103, an embodiment of the invention allows arbitrary mappings between the unique storage addresses of storage blocks in the virtual storage array and the corresponding unique storage addresses in one or more physical data storage devices 103. In an embodiment, the mapping between virtual and physical storage address may be performed by a branch location virtual storage array interface 137 and/or by data center virtual storage array interface 107. Furthermore, there may be multiple levels of mapping between the addresses of storage blocks in the virtual storage array and their corresponding addresses in the physical storage device.

In an embodiment, storage blocks in the virtual storage array may be of a different size and/or structure than the corresponding storage blocks in a physical storage array or data storage device. For example, if data compression is applied to the storage data, then the physical storage array data blocks may be smaller than the storage blocks of the virtual storage array to take advantage of data storage savings. In an embodiment, the branch location and/or data center virtual storage array interfaces map one or more virtual storage array storage blocks to one or more physical storage array storage blocks. Thus, a virtual storage array storage block can correspond with a fraction of a physical storage array storage block, a single physical storage array storage block, or multiple physical storage array storage blocks, as required by the configuration of the virtual and physical storage arrays.

In a further embodiment, the prefetching agent 153, branch location 135, and/or data center 107 virtual storage array interfaces may reorder or regroup storage operations to improve efficiency of data optimizations such as data compression. For example, if two storage clients are simultaneously accessing the same virtual storage array, then these storage operations will be intermixed when received by the branch location virtual storage array interface. An embodiment of the branch location and/or data center virtual storage array interface can reorder or regroup these storage operations according to storage client, type of storage operation, data or application type, or any other attribute or criteria to improve virtual storage array performance and efficiency. For example, a virtual storage array interface can group storage operations by storage client and apply data compression to each storage client's operations separately, which is likely to provide greater data compression than compressing all storage operations together.

As described above, an embodiment of the virtualized data storage system architecture 100 attempts to predict which storage blocks will be requested by a storage client in the near future, prefetches these storage blocks from the physical data storage devices 103, and forwards these to the branch location 102 for storage in the storage block read cache 147. When this prediction is successful and storage block requests may be fulfilled in whole or in part from the block read cache 147, the latency and bandwidth restrictions of the WAN 130 are hidden from the storage client. An embodiment of the virtualized data storage system architecture 100 includes a storage block access optimizer 120 to select storage blocks for prefetching to storage clients. In an embodiment, the storage block access optimizer 120 is located at the data center 101 and is connected or incorporated into the data center virtual data storage array interface 107. In an alternate embodiment, the storage block access optimizer 120 may be located at the branch location 102 and be connected with or incorporated into the branch location virtual data storage interface 135.

As discussed above, storage devices such as physical data storage arrays and the virtual data storage array are accessed using storage block-based protocols. A storage block is a sequence of bytes or bits of data. Data storage devices represent their data storage as a set of storage blocks that may be used to store and retrieve data. The set of storage blocks is an abstraction of the underlying hardware of a physical or virtual data storage device. Storage clients use storage block-based protocols to specify reads, writes, modifications, and/or deletions of storage blocks. However, servers and higher-level applications typically access data in terms of files in a structured file system, relational database, or other high-level data structure. Each entity in the high-level data structure, such as a file or directory, or database table, node, or row, may be spread out over multiple storage blocks at various non-contiguous locations in the storage device. Thus, prefetching storage blocks based solely on their location in the storage device is unlikely to be effective in hiding WAN latency and bandwidth limits from storage clients.

In an embodiment, the prefetching agents 153A, 153B, and 153C monitor application storage accesses on their respective clients or servers 152A and 152B or other storage clients 139 to generate additional storage block prefetching information. Storage block prefetching information includes information used to predict which storage blocks are likely to be requested by a storage client in the near future. Storage block prefetching information may include any attributes or information relevant for predicting application behavior and/or future storage block access requests. Examples of storage block prefetching information include the file name, file type, and/or file path corresponding with a storage block access request; the identity of any other high-level data structure associated with the storage block access request; and/or the identity of the application or other process making the storage block access request. In a further example of storage block prefetching information, if a storage block access request corresponds with data in specific data structure within a file, such as a section or stream in a container file, the storage block prefetching information may identify the data structure in this file. Prefetching agents may monitor any aspect of the operation of their respective host systems, including application or other process behavior, input, and output; resource usage; and user input.

In an embodiment, the storage block access optimizer 120 leverages an understanding of the semantics and structure of the high-level data structures associated with the storage blocks to predict which storage blocks are likely to be requested by a storage client in the near future. To do this, the storage block access optimizer 120 must be able to determine the association between storage blocks and its high-level data structure. In one embodiment, the storage block access optimizer 120 uses the storage block prefetching information to identify the high-level data structure associated with requested storage blocks. In a further embodiment, the storage block access optimizer 120 may also use storage block prefetching information to help select one or more additional storage blocks for prefetching, for example based on the identity or type of application requesting a storage block.

In addition to or instead of storage block prefetching information, an optional embodiment of the storage block access optimizer 120 uses an inferred storage structure database (ISSD) 123 to match storage blocks with their associated entity in the high-level data structure. For example, given a specific storage block location, the storage block access optimizer 120 may use the ISSD 123 to identify the file or directory in a file system, or the database table, record, or node, that is using this storage block to store some or all of its data.

Once the storage block access optimizer 120 has identified the high-level data structure entity associated with a storage block, the storage block access optimizer 120 may employ a number of different techniques to predict which additional storage blocks are likely to be requested by a storage client. For example, storage block access optimizer 120 may observe requests from a storage clients 139 and 152A for storage blocks from the virtual data storage array 137, identify the high-level data structure entities associated with the requested storage blocks using the storage block prefetching information provided by prefetching agents and optionally the ISSD, and select additional storage blocks associated with these or other high-level data structure entities for prefetching. These types of storage block prefetching techniques are referred to as reactive prefetching.

In another example, the storage block access optimizer 120 may analyze entities in the high-level data structures, such as files, directories, or database entities, to identify specific entities or portions thereof that are likely to be requested by the storage clients 139 and 152A. The storage block access optimizer 120 identifies storage blocks corresponding with these identified entities or portions thereof and prefetches these storage blocks for storage in the block read cache 147 at the branch location 102. These types of storage block prefetching techniques are referred to as policy-based prefetching. Further examples of reactive and policy-based prefetching are discussed below. Embodiments of the storage block access optimizer 120 may utilize any combination of reactive and policy-based prefetching techniques to select storage blocks to be prefetched and stored in the block read cache 147 at the branch location 102.

In the example virtualized data storage system architecture 100, the storage block access optimizer 120 is located at the data center location 101. However, alternate embodiments of the invention may locate the storage block access optimizer 120 at the branch location 102 as a separate module, integrated with the branch virtual storage array interface 135, or included in each of the storage clients 139 and 152A, for example being integrated with each of the prefetching agents 153.

Further embodiments of the invention may be used in different network architectures. For example, a data center virtual storage array interface 107 may be connected directly between WAN 130 and a physical data storage array 103, eliminating the need for a data center LAN. Similarly, a branch location virtual storage array interface 135, implemented for example in the form of a software application executed by a storage client computer system, may be connected directly with WAN 130, such as the internet, eliminating the need for a branch location LAN. In another example, the data center and branch location virtual data storage array interfaces 107 and 135 may be combined into a single unit, which may be located at the branch location 102.

In a further embodiment, the branch location 102 and data center location 101 may optionally include network optimizers 125, such as WAN optimization modules 125A and 125B, for improving the performance of data communications over the WAN between branches and/or the data center. Network optimizers 125 can improve actual and perceived WAN network performance using techniques including compressing data communications; anticipating and prefetching data; caching frequently accessed data; shaping and restricting network traffic; and optimizing usage of network protocols. In an embodiment, network optimizers 125 may be used in conjunction with virtual data storage array interfaces 107 and 135 to further improve virtual storage array 137 performance for storage blocks accessed via the WAN 130. In other embodiments, network optimizers 125 may ignore or pass-through virtual storage array 137 data traffic, relying on the virtual storage array interfaces 107 and 135 at the data center 101 and branch location 102 to optimize WAN performance.

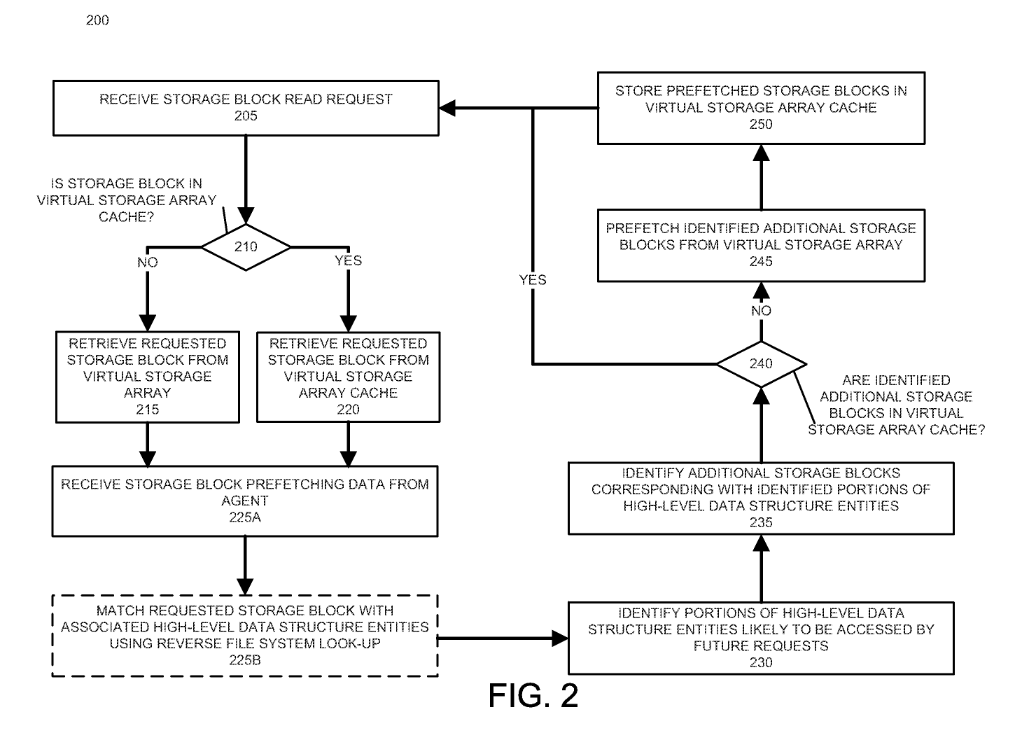

FIG. 2 illustrates a method 200 of prefetching storage blocks to improve virtualized data storage system performance according to an embodiment of the invention. Step 205 receives a storage block read request from a storage client at the branch location. In an embodiment, the storage block read request may be received by a branch location virtual data storage array interface.

In response to the receipt of the storage block read request in step 205, decision block 210 determines if the requested storage block has been previously retrieved and stored in the storage block read cache at the branch location. If so, step 220 retrieves the requested storage block from the storage block read cache and returns it to the requesting storage client. In an embodiment, if the system includes a data center virtual storage array interface, then step 220 also forwards the storage block read request back to the data center virtual storage array interface for use in identifying additional storage blocks likely to be requested by the storage client in the future.

If the storage block read cache at the branch location does not include the requested storage block, step 215 retrieves the requested storage block via a WAN connection from the virtual storage array data located in a physical data storage at the data center. In an embodiment, a branch location virtual storage array interface forwards the storage block read request to the data center virtual storage array interface via the WAN connection. The data center virtual storage array interface then retrieves the requested storage block from the physical storage array and returns it to the branch location virtual storage array interface, which in turn provides this requested storage block to the storage client. In a further embodiment of step 215, a copy of the retrieved storage block may be stored in the storage block read cache for future accesses.

During and/or following the retrieval of the requested storage block from the virtual storage array or virtual storage array cache, steps 225A to 250 prefetch additional storage blocks likely to be requested by the storage client in the near future. Step 225A receives storage block prefetching data from a prefetching agent. (If method 200 is implemented within a prefetching agent, rather than one of the virtual storage array interfaces or other entity, this step may be omitted.) The storage block prefetching data identifies the high-level data structure entity associated with the requested storage block. Typical block storage protocols, such as iSCSI and FCP, specify block read requests using a storage block address or identifier. However, these storage block read requests do not include any identification of the high-level data structure, such as a file, directory, or database entity, that is associated with this storage block. Therefore, an embodiment of the prefetching agent provides the virtual storage array interface with the storage block prefetching data that identifies, at the least, the high-level data structure, such as a file, directory, or database entity, corresponding with the storage block read request. In further embodiments, the prefetching agent may provide other information in the storage block prefetching data, such as a specific address or offset within the file or high-level data structure entity corresponding with the storage block request and/or the identity or type of application requesting the storage block.

In addition to receiving storage block prefetching data, an embodiment of method 200 may also optionally perform step 225B and access an ISSD to identify the high-level data structure associated with the requested storage block. In an embodiment, optional step 225B provides the ISSD with the storage block address or identifier. In response, the ISSD returns an identifier of the high-level data structure entity associated with the requested storage block. The identifier of the high-level data structure entity may be an inode or similar file system identifier or a database storage structure identifier, such as a database table or B-tree node. In a further embodiment, the ISSD also includes a location within the high-level data structure entity corresponding with the requested storage block. For example, step 225 may provide a storage block identifier to the ISSD and in response receive the inode or other file system identifier for a file stored in this storage block. Additionally, the ISSD can return an offset, index, or other file location indicator that specifies the portion of this file stored in the storage block.

Using the identification of the high-level data structure entity and other storage block prefetching data received in step 225A and optionally data provided by the ISSD in step 225B, step 230 identifies additional high-level data structure entities or portions thereof that are likely to be requested by the storage client. There are a number of different techniques for identifying addition high-level data structure entities or portions thereof for prefetching that may be used by embodiments of step 230. Some of these are described in detail in co-pending U.S. patent application Ser. No. 12/730,198, entitled “Virtual Data Storage System Optimizations”, filed Mar. 23, 2010, which is incorporated by reference herein for all purposes.

One example technique is to prefetch portions of the high-level data structure entity based on their adjacency or close proximity to the identified portion of the entity. For example, if step 225A determines that the requested storage block corresponds with a portion of a file from file offset 0 up to offset 4095, then step 230 may identify a second portion of this same file beginning with offset 4096 for prefetching. It should be noted that although these two portions are adjacent in the high-level data structure entity, their corresponding storage blocks may be non-contiguous.

Another example technique is to identify the application or process or type of application or process requesting the storage block and then apply one or more heuristics to identify additional portions of this high-level data structure entity or a related high-level data structure entity for prefetching. For example, an antivirus application may typically retrieve data from all of the files in a directory and its subdirectories. Thus, in this example, step 230 may prefetch storage blocks corresponding to all of the files in a directory associated with a storage block and any subdirectories of this directory. In another example, if an application development environment, such as a build system and compiler, typically access recently updated files, then an example heuristic applied by step 230 may prefetch storage blocks holding file system metadata such as timestamps for other files in the directory and subdirectories associated with a requested storage block.

Similarly, if an application or process requesting the storage block is associated with a listing or copy operation of a file system directory, an example embodiment of step 230 may prefetch storage blocks associated with the files and/or subdirectories associated with this directory. In this example, step 230 may prefetch storage blocks associated with a single level of a file system hierarchy or recursively prefetch storage blocks associated with multiple levels of the file system hierarchy.

In another example technique, an embodiment of method 200 analyzes application or operating system log files or other data structures to identify the sequence of files or other high-level data structure entities accessed during operations such an operating system or application start-up. Storage blocks corresponding with this sequence of files or other high-level data structure entities may be selected for prefetching.

Another example technique is to identify the type of high-level data structure entity, such as a file of a specific format, a directory in a file system, or a database table, and apply one or more heuristics to identify additional portions of this high-level data structure entity or a related high-level data structure entity for prefetching. For example, applications employing a specific type of file may frequently access data at a specific location within these files, such as at the beginning or end of the file. Using knowledge of this application or entity-specific behavior, step 230 may identify these frequently accessed portions of the file for prefetching.

Yet another example technique monitors the times at which high-level data structure entities are accessed. High-level data structure entities that are accessed at approximately the same time are associated together by the virtual storage array architecture. If any one of these associated high-level data structure entities is later accessed again, an embodiment of step 230 identifies one or more associated high-level data structure entities that were previously accessed at approximately the same time as the requested high-level data structure entity for prefetching. For example, a storage client may have previously requested storage blocks from files A, B, and C at approximately the same time, such as within a minute of each other. Based on this previous access pattern, if step 225A determines that a requested storage block is associated with file A, step 230 may identify all or portions of files B and C for prefetching.

Further example techniques may utilize predetermined lists of related high-level data structure entities. Each predetermined list is associated with at least one access pattern of storage blocks and/or high-level data structure entities. When an access pattern of a process or application matches that associated with one or more predetermined lists, an embodiment of step 230 prefetches the high-level data structure entities (or portions thereof) specified by the predetermined list.

In still another example technique, step 230 analyzes the high-level data structure entity associated with the requested storage block to identify related portions of the same or other high-level data structure entity for prefetching. For example, application files may include references to additional files, such as overlay files or dynamically loaded libraries. Similarly, a database table may include references to other database tables. Once step 225A identifies the high-level data structure entity associated with a requested storage block, step 230 may use an analysis of this high-level data structure entity to identify additional referenced high-level data structure entities. The referenced high-level data structure entities may be prefetched. In an embodiment, the analysis of high-level data structure entities for references to other high-level data structure entities may be performed asynchronously with method 200.

Step 230 identifies all or portions of one or more high-level data structure entities for prefetching based on the high-level data structure entity associated with the requested storage block. However, as discussed above, storage clients specify data access requests in terms of storage blocks, not high-level data structure entities such as files, directories, or database tables. Thus, step 235 needs to identify one or more storage blocks corresponding with the high-level data structure entities identified for prefetching in step 230. In an embodiment, step 235 provides the ISSD with identifiers for one or more high-level data structure entities, such as the inodes of files or similar identifiers for other types of file systems or database storage structures. Optionally, step 235 also provides an offset, file location, or other type of address identify a specific portion of a high-level data structure entity to be prefetched. In response, the ISSD returns an identifier of one or more storage blocks associated with the high-level data structure entities. These identified storage blocks are used to store the high-level data structure entities or portions thereof

Decision block 240 determines if the storage blocks identified in step 235 have already been stored in the storage block read cache located at the branch location. In an embodiment, the storage block access optimizer at the data center maintains a record of all of the storage blocks that have copies stored in the storage block read cache. In an alternate embodiment, the storage block access optimizer queries the branch location virtual storage array interface to determine if copies of these identified storage blocks have already been stored in the storage block read cache.

In still a further embodiment, decision block 240 and the determination of whether an additional storage block has been previously retrieved and cached may be omitted. Instead, this embodiment can send all of the additional storage blocks identified by step 235 to the branch location virtual storage array interface to be cached. This embodiment can be used when WAN latency, rather than WAN bandwidth limitations, are an overriding concern.

If all of the identified storage blocks from step 235 are already stored in the storage block read cache, then method 200 proceeds from decision block 240 back to step 205 to await receipt of further storage block requests.

If some or all of the storage blocks identified in step 235 are not already stored in the storage block read cache, then step 245 retrieves these uncached storage blocks from the virtual storage array data located in a physical data storage on the data center LAN. The retrieved storage blocks are sent via the WAN connection from the data center location to the branch location. In an embodiment of step 245, the data center virtual storage array interface receives a request for the uncached identified storage blocks from the storage block access optimizer and, in response, accesses the physical data storage array to retrieve these storage blocks. The data center virtual storage array interface then forwards these storage blocks to the branch location virtual storage array interface via the WAN connection.

Step 250 stores the storage blocks identified for prefetching in the storage block read cache. In an embodiment of step 250, the branch location virtual storage array interface receives one or more storage blocks from the data center virtual storage array interface via the WAN connection and stores these storage blocks in the storage block read cache. Following step 250, method 200 proceeds to step 205 to await receipt of further storage block requests. The storage blocks added to the storage block read cache in previous iterations of method 200 may be available for fulfilling storage block read requests.

Method 200 may be performed by a branch virtual data storage array interface, by a data center virtual data storage array interface, by both virtual data storage array interfaces working in concert, or by a prefetching agent operating on a client, server, or other storage client. For example, steps 205 to 220 of method 200 may be performed by a branch location virtual storage array interface and steps 225 to 250 of method 200 may be performed by a data center virtual storage array interface. In another example, all of the steps of method 200 may be performed by a branch location virtual storage array interface.

Embodiments of method 200 utilize the ISSD to identify storage blocks from their associated high-level data structure entities and/or optionally to identify high-level data structure entities from storage blocks. An embodiment of the invention creates the ISSD by initially searching high-level data structure entities, such as a master file table, allocation table or tree, or other types of file system metadata structures, to identify the high-level data structure entities corresponding with the storage blocks. An embodiment of the invention may further recursively analyze other high-level data structure entities, such as inodes, directory structures, files, and database tables and nodes, that are referenced by the master file table or other high-level data structures. This initial analysis may be performed by either the branch location or data center virtual storage array interface as a preprocessing activity or in the background while processing storage client requests. In an embodiment, the ISSD may be updated frequently or infrequently, depending upon the desired prefetching performance. Embodiments of the invention may update the ISSD by periodically scanning the high-level data structure entities or by monitoring storage client activity for changes or additions to the virtual storage array, which is then used to update the affected portions of the ISSD.

As described above, embodiments of the invention prefetch storage blocks from the data center storage array and cache these storage blocks in a storage block cache located at the branch location. In some embodiments, the storage block cache may be smaller than the virtual storage array. Thus, when the storage block cache is full, the branch or data center virtual storage array interface may need to occasionally evict or remove some storage blocks from the storage block cache to make room for other prefetched storage blocks. In an embodiment, the branch virtual storage array interface may use any cache replacement scheme or policy known in the art, such as a least recently used (LRU) cache management policy.

In another embodiment, the storage block cache replacement policy of the storage block cache is based on an understanding of the relationship between storage blocks and corresponding high-level data structure entities, such as file system or database entities. In this embodiment, even though the storage block cache operates on the basis of storage blocks, the storage block cache replacement policies determine whether to retain or evict storage blocks in the storage block cache based on their associations to files or other high level data structure entities.

For example, when a virtual storage array interface needs to evict storage blocks from the storage block cache to create free space for other prefetched storage blocks, an embodiment of the virtual storage interface uses information associating storage blocks with corresponding files to evict all of the storage blocks associated with a single file, rather than evicting some storage blocks from one file and some from another file. In this example, storage blocks are not necessarily evicted based on their own usage alone, but on the overall usage of their associated file or other high-level data structure entity.

As another example, the storage block cache may elect to preferentially retain storage blocks including file system metadata and/or directory structures over other storage blocks that include file data only.

In yet another example, the storage block cache may identify files or other high-level data structure entities that have not been accessed recently, and then use the ISSD to identify and select the storage blocks corresponding with these infrequently used files for eviction.

Although these examples of storage block cache replacement policies are discussed with reference to file and file systems, similar techniques can be applied to databases and other types of high-level data structure entities.

In addition to selectively evict storage blocks based on their associated high-level data structure entities, an embodiment of the virtual array storage system can also include cache policies to preferentially retain or “pin” specific storage blocks in the storage block cache, regardless of their usage or other factors. These cache retention policies can ensure that specific storage blocks are always accessible at the branch location, even at times when the WAN is unavailable, since copies of these storage blocks will always exist in the storage block cache.

In this embodiment, a user, administrator, or administrative application may specify all or a portion of the virtual storage array for preferential retention or pinning in the storage block cache. Upon receiving a request to pin some or all of the virtual storage array data in the storage block cache, the virtual storage array system needs to determine if the storage block cache has sufficient additional capacity to store the specified storage blocks. If the storage block cache has sufficient capacity, the virtual storage array system is allowed to reserves space in the storage block cache for the specified storage blocks; otherwise this request is denied.

If the storage block cache has sufficient capacity to satisfy the pinning request, the cache also may initiate a proactive prefetch process to retrieve any requested storage blocks that are not already in the storage block cache from the data center via the WAN. For large pinning requests, such as an entire virtual storage array, it may take hours or days for this proactive prefetch to be completed. In a further embodiment, this proactive prefetching of pinned storage blocks may be performed asynchronously and at a lower priority than storage clients' requests for virtual storage array read operations, associated prefetching (discussed above), and the virtual storage array write operations (discussed below). This embodiment may be used to deploy data to a new branch location. For example, upon activation of the branch storage array interface, the virtual storage array data is copied asynchronously via the WAN to the branch location storage block cache. Although this data transfer may take some time to complete, storage clients at this new branch location can access virtual storage array data immediately using the virtual storage array read and write operations, with the above-described storage block prefetching hiding the bandwidth and latency limitations of the WAN when storage clients access storage blocks that have yet to be copied to the branch location.

In another embodiment, the storage block cache may allow users, administrators, and administration applications the ability to directly specify the pinning of high-level data structure entities, such as files or database elements, as opposed to specifying storage blocks for pinning in the storage block cache. In this embodiment, the virtual storage array uses the ISSD to identify storage blocks corresponding with the specified high-level data structure entities. In a further embodiment, the virtual storage array may allow user, administrators, and administrative applications to specify only a portion of high-level data structure entities for pinning, such as file metadata and frequently used indices within high-level data structure entities. The virtual storage array then uses the associations between storage blocks and high-level data structure entities from the ISSD to identify specific storage blocks to be pinned in the storage block cache.

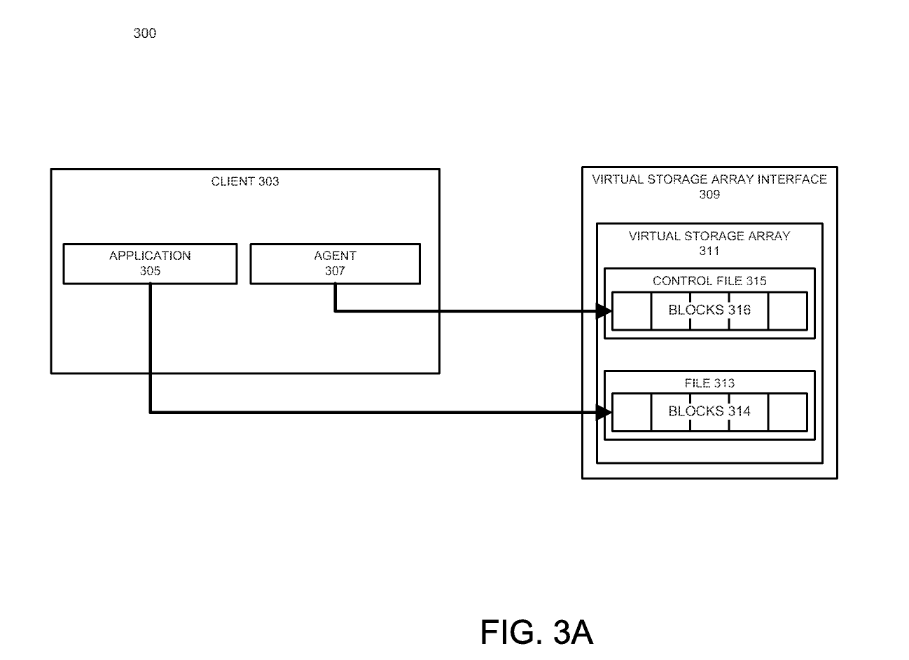

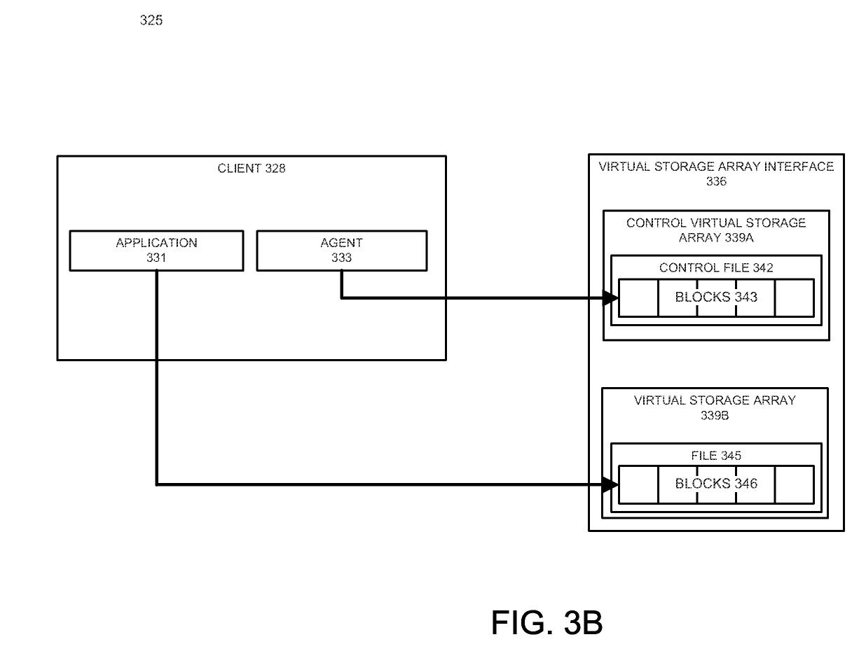

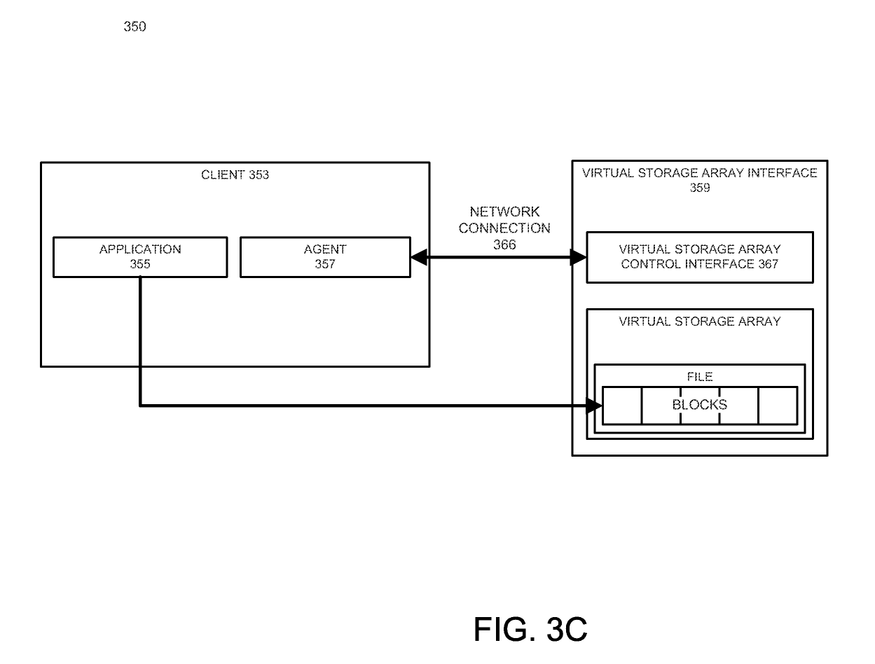

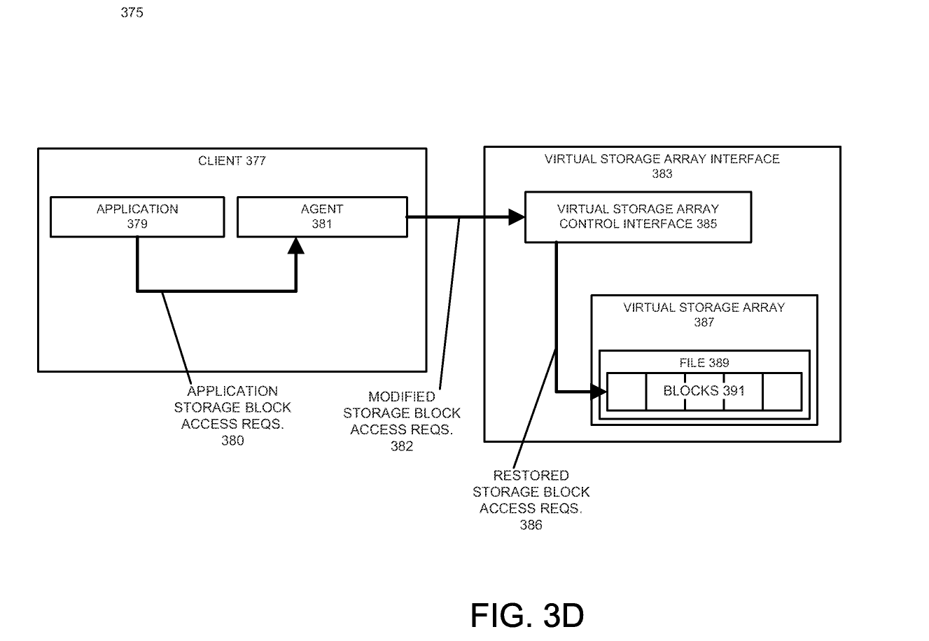

As discussed above, step 225A of method 200 receives storage block prefetching data from the prefetching agent in some embodiments of the invention. Embodiments of the invention may communicate storage block prefetching information from a prefetching agent to a virtual storage array interface using any communications technique and/or protocol known in the art. FIGS. 3A-3D illustrate several example techniques for communicating storage block prefetching information between a prefetching agent and a virtual storage array interface.

FIG. 3A illustrates a first example technique 300 communicating storage block prefetching information between a prefetching agent 307 and a virtual storage array interface 309. In example 300, a client 303 includes one or more applications or other processes 305 issuing high-level storage access requests, such as requests for files or portions thereof. Prefetching agent 307 monitors these requests as well as the corresponding low-level storage block requests to generate storage block prefetching data that matches these two types of storage requests.

In this example 300, the prefetching agent 307 provides the virtual storage array interface 309 with the storage block prefetching data by writing this data to a special “control file” 315 in the virtual storage array 315. In example 300, the control file 315 is located in the same virtual storage array 311 and logical storage unit, or LUN, as files accessed by the application 305. The identity and location of the control file 315 is known to the virtual storage array interface 309 based on a system configuration or by signaling between the prefetching agent 307 and the virtual storage array interface 309. The virtual storage array interface 309 monitors the contents of the control file to identify the file or other high-level data structure entity associated with incoming storage block access requests.

For example, application 305 issues high-level storage access requests to read data from file 313. A file server, file system, operating system, and/or components such as device drivers translate these high-level storage access into low-level storage block access requests for storage blocks 314 in the virtual storage array 311. Prefetching agent 307 monitors both the application's 305 high-level storage access requests and the corresponding low-level storage block requests to generate the storage block prefetching information. Prefetching agent 307 then writes this storage block prefetching information into control file 315 in the virtual storage array. The virtual storage array interface 309 monitors the contents of the storage blocks 316 associated with the control file 315. In this manner, the virtual storage array interface 309 receives the storage block prefetching data from the prefetching agent 307 and can use this information to associate storage blocks 314 accessed using low-level storage block access requests with the file 313 as well as application 305 and other information provided by the prefetching agent 307. The virtual storage array interface 309 may then prefetch additional storage blocks accordingly.

FIG. 3B illustrates a second example technique 325 communicating storage block prefetching information between a prefetching agent 333 and a virtual storage array interface 336. In example 325, a client 328 includes one or more applications or other processes 311 issuing high-level storage access requests, such as requests for files or portions thereof. Prefetching agent 333 monitors these requests as well as the corresponding low-level storage block requests to generate storage block prefetching data that matches these two types of storage requests.

In this example 325, the prefetching agent 333 provides the virtual storage array interface 336 with the storage block prefetching data by writing this data to a special “control file” 342 in a control virtual storage array 339A. In example 300, the control file 342 is located in a different virtual storage array 339A and logical storage unit, or LUN, than that used to store files accessed by the application 305. Embodiments implementing example 325 may use a single control file 342 in a separate virtual storage array 339A and/or LUN or use multiple control files, such as one control file corresponding with each actual file in virtual storage array 339B. The identity and location of the control file 342 is known to the virtual storage array interface 336 based on a system configuration or by signaling between the prefetching agent 333 and the virtual storage array interface 336. The virtual storage array interface 336 monitors the contents of the control file 342 directly or accesses to control virtual storage array 339A generally to identify the file or other high-level data structure entity associated with incoming storage block access requests.

For example, application 331 issues high-level storage access requests to read data from file 345. A file server, file system, operating system, and/or components such as device drivers translate these high-level storage access into low-level storage block access requests for storage blocks 346 in the virtual storage array 339B. Prefetching agent 333 monitors high-level storage access requests and the corresponding low-level storage block requests to generate the storage block prefetching information and then writes this storage block prefetching information into control file 342 in the virtual storage array. The virtual storage array interface 336 monitors the contents of the storage blocks 343 associated with the control file 342 to receive the storage block prefetching data from the prefetching agent 333. Virtual storage array interface 336 uses this information to associate storage blocks 346 accessed using low-level storage block access requests with the file 345, application 331, and any other information provided by the prefetching agent 333. The virtual storage array interface 336 may then prefetch additional storage blocks accordingly.

FIG. 3C illustrates a third example technique 350 communicating storage block prefetching information between a prefetching agent 357 and a virtual storage array interface 359. In example 350, a client 353 includes one or more applications or other processes 355 issuing high-level storage access requests, such as requests for files or portions thereof. Prefetching agent 357 monitors these requests as well as the corresponding low-level storage block requests to generate storage block prefetching data that matches these two types of storage requests. Prefetching agent 357 then communicates the storage block prefetching data with a virtual storage array control interface 367 via a network connection 366, such as a TCP/IP network connection.

FIG. 3D illustrates a fourth example technique 375 communicating storage block prefetching information between a prefetching agent 381 and a virtual storage array interface 383. In example 375, a client 377 includes one or more applications or other processes 379 issuing high-level storage access requests, such as requests for files or portions thereof. Prefetching agent 381 monitors these requests as well as the corresponding low-level storage block requests to generate storage block prefetching data that matches these two types of storage requests.

In example 375, prefetching agent 381 intercepts the application's storage block access requests 380 from the file server, file system, operating system, and/or components such as device drivers. Prefetching agent 381 then generates modified storage block access requests 382 that includes corresponding storage block prefetching data in addition to the application's storage block access requests 380. The storage block prefetching data may be included in the modified storage block access requests 382 in the form of metadata added to storage commands and/or additional storage commands.

A virtual storage array control interface 385 included in the virtual storage array interface 383 receives the modified storage access requests 382 and extracts the storage block prefetching data. The virtual storage array control interface 385 then generates restored storage block access requests 386 that match the application's original storage block access requests 380 and use these to access the storage blocks 391 in the virtual storage array 387. Using the storage block prefetching data, the virtual storage array interface 383 can match these storage blocks 391 with file 389, application 379, and any other data included by the prefetching agent 381 in the storage block prefetching data.

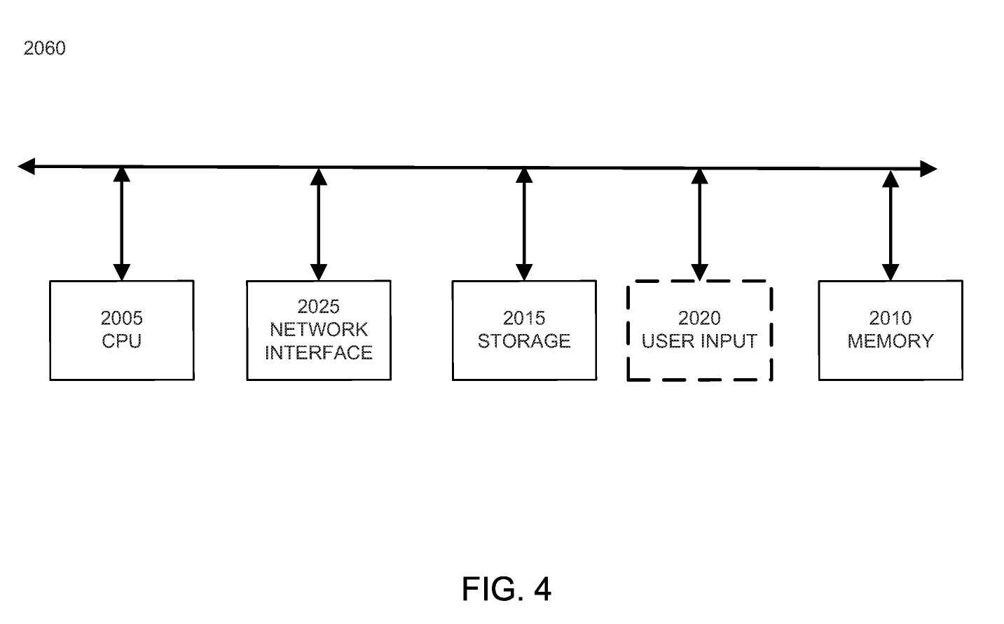

Embodiments of the invention can implement virtual storage array interfaces at the branch and/or data center as standalone devices or as part of other devices, computer systems, or applications. FIG. 4 illustrates an example computer system capable of implementing a virtual storage array interface according to an embodiment of the invention. FIG. 4 is a block diagram of a computer system 2000, such as a personal computer or other digital device, suitable for practicing an embodiment of the invention. Embodiments of computer system 2000 may include dedicated networking devices, such as wireless access points, network switches, hubs, routers, hardware firewalls, network traffic optimizers and accelerators, network attached storage devices, storage array network interfaces, and combinations thereof

Computer system 2000 includes a central processing unit (CPU) 2005 for running software applications and optionally an operating system. CPU 2005 may be comprised of one or more processing cores. In a further embodiment, CPU 2005 may execute virtual machine software applications to create one or more virtual processors capable of executing additional software applications and optional additional operating systems. Virtual machine applications can include interpreters, recompilers, and just-in-time compilers to assist in executing software applications within virtual machines. Additionally, one or more CPUs 2005 or associated processing cores can include virtualization specific hardware, such as additional register sets, memory address manipulation hardware, additional virtualization-specific processor instructions, and virtual machine state maintenance and migration hardware.

Memory 2010 stores applications and data for use by the CPU 2005. Examples of memory 2010 include dynamic and static random access memory. Storage 2015 provides non-volatile storage for applications and data and may include fixed or removable hard disk drives, flash memory devices, ROM memory, and CD-ROM, DVD-ROM, Blu-ray, or other magnetic, optical, or solid state storage devices. In an embodiment, storage 2015 includes multiple storage devices configured to act as a storage array for improved performance and/or reliability. In a further embodiment, storage 2015 includes a storage array network utilizing a storage array network interface and storage array network protocols to store and retrieve data. Examples of storage array network interfaces suitable for use with embodiments of the invention include Ethernet, Fibre Channel, IP, and InfiniBand interfaces. Examples of storage array network protocols include ATA, Fibre Channel Protocol, and SCSI. Various combinations of storage array network interfaces and protocols are suitable for use with embodiments of the invention, including iSCSI, HyperSCSI, Fibre Channel over Ethernet, and iFCP.

Optional user input devices 2020 communicate user inputs from one or more users to the computer system 2000, examples of which may include keyboards, mice, joysticks, digitizer tablets, touch pads, touch screens, still or video cameras, and/or microphones. In an embodiment, user input devices may be omitted and computer system 2000 may present a user interface to a user over a network, for example using a web page or network management protocol and network management software applications.

Computer system 2000 includes one or more network interfaces 2025 that allow computer system 2000 to communicate with other computer systems via an electronic communications network, and may include wired or wireless communication over local area networks and wide area networks such as the Internet. Computer system 2000 may support a variety of networking protocols at one or more levels of abstraction. For example, computer system may support networking protocols at one or more layers of the seven layer OSI network model. An embodiment of network interface 2025 includes one or more wireless network interfaces adapted to communicate with wireless clients and with other wireless networking devices using radio waves, for example using the 802.11 family of protocols, such as 802.11a, 802.11b, 802.11g, and 802.11n.

An embodiment of the computer system 2000 may also include a wired networking interface, such as one or more Ethernet connections to communicate with other networking devices via local or wide-area networks.

The components of computer system 2000, including CPU 2005, memory 2010, data storage 2015, user input devices 2020, and network interface 2025 are connected via one or more data buses 2060. Additionally, some or all of the components of computer system 2000, including CPU 2005, memory 2010, data storage 2015, user input devices 2020, and network interface 2025 may be integrated together into one or more integrated circuits or integrated circuit packages. Furthermore, some or all of the components of computer system 2000 may be implemented as application specific integrated circuits (ASICS) and/or programmable logic.

Further embodiments can be envisioned to one of ordinary skill in the art after reading the attached documents. For example, embodiments of the invention can be used with any number of network connections and may be added to any type of network device, client or server computer, or other computing device in addition to the computer illustrated above. In other embodiments, combinations or sub-combinations of the above disclosed invention can be advantageously made. The block diagrams of the architecture and flow charts are grouped for ease of understanding. However it should be understood that combinations of blocks, additions of new blocks, re-arrangement of blocks, and the like are contemplated in alternative embodiments of the present invention.

The specification and drawings are, accordingly, to be regarded in an illustrative rather than a restrictive sense. It will, however, be evident that various modifications and changes may be made thereunto without departing from the broader spirit and scope of the invention as set forth in the claims.

What is claimed is:

1. A method of optimizing a block storage protocol access to a block storage device, the method comprising:
receiving a first storage request for access to a first storage block from a storage client;
receiving storage block prefetching information from a prefetching agent monitoring the storage client;
using the storage block prefetching information, identifying a first high-level data structure entity corresponding with the first storage block;
analyzing the first high-level data structure entity to identify at least at a portion of a set of high-level data structure entities likely to be associated with at least one future storage request;
identifying a second storage block corresponding with the portion of the set of high-level data structure entities; and
communicating the second storage block from a physical storage array to a storage block cache via a wide-area network.

2. The method of claim 1, wherein analyzing the first high-level data structure entity comprises:
using the storage block prefetching information in addition to the first high-level data structure entity to identify the portion of a set of high-level data structure entities.

3. The method of claim 2, wherein the storage block prefetching information includes an identity of a storage client application associated with the first storage request.

4. The method of claim 1, wherein the prefetching agent is operating on the storage client.

5. The method of claim 4, wherein the prefetching agent is included in an application or a background process operating on the storage client.

6. The method of claim 4, wherein the prefetching agent is included in a driver module operating on the storage client.

7. The method of claim 1, wherein the storage client is operating within a virtual machine and the prefetching agent is included in a virtualization platform including the virtual machine.

8. The method of claim 1, wherein receiving the storage block prefetching information from the prefetching agent comprises:
monitoring a predetermined control file to detect the storage of the storage block prefetching information in the predetermined control file.

9. The method of claim 8, wherein the predetermined control file and the first high-level data structure entity are included in the same virtual storage array.

10. The method of claim 8, wherein the predetermined control file and the first high-level data structure entity are included in different virtual storage arrays.

11. The method of claim 1, wherein the first high-level data structure entity is included in a first virtual storage array and receiving the storage block prefetching information from the prefetching agent comprises:
monitoring a second virtual storage array for second storage requests from the prefetching agent.

12. The method of claim 11, wherein the second storage requests include a write operation to a copy of the first high-level data structure entity included in the second virtual storage array.

13. The method of claim 1, wherein receiving the storage block prefetching information from the prefetching agent comprises:
receiving the storage block prefetching information via a network connection with the prefetching agent.

14. The method of claim 1, wherein receiving the storage block prefetching information from the prefetching agent comprises:
receiving the storage block prefetching information via a network connection with the prefetching agent.

15. The method of claim 1, wherein receiving the storage block prefetching information from the prefetching agent comprises:
receiving the storage block prefetching information via a storage block protocol.

16. The method of claim 15, wherein the storage block prefetching information is included in metadata added to storage block access requests via the storage block protocol.

17. The method of claim 16, wherein the metadata is included in the first storage request.

18. The method of claim 1, wherein the storage block cache is included in a local network including the storage client.

19. The method of claim 1, wherein the storage block cache is included in the storage client.

20. The method of claim 1, wherein the first high-level data structure entity includes a file.
